(19) United States
(12) Patent Application Publication
(10) Pub. No.: US 2023/0046215 A1
(43) Pub. Date: Feb. 16, 2023

(54) ELECTRODE BINDER FOR LITHIUM SECONDARY BATTERY, AND ELECTRODE AND LITHIUM SECONDARY BATTERY INCLUDING THE SAME

(71) Applicants: Samsung SDI Co., Ltd., Yongin-si (KR); Seoul National University R&DB Foundation, Seoul (KR)

(72) Inventors: Jungmin Lee, Yongin-si (KR); Jangwook Choi, Seoul (KR); Yunshik Cho, Yongin-si (KR); Jaemin Kim, Seoul (KR); Kiho Park, Seoul (KR)

(21) Appl. No.: 17/882,445

(22) Filed: Aug. 5, 2022

(30) Foreign Application Priority Data
Aug. 6, 2021 (KR) 10-2021-0104198

(51) Int. Cl. H01M 4/62; H01M 10/0525; H01M 4/583

(52) U.S. Cl. CPC H01M 4/622; H01M 10/0525; H01M 4/583; H01M 2004/027

(57) ABSTRACT

An electrode binder for a lithium secondary battery, and an electrode and a lithium secondary battery, including the electrode binder. The electrode binder includes: a cellulose-based graft copolymer grafted with a compound having an ion-hopping site; and a polyacrylate-based polymer having an anionic group via an exchange with a cation. By including the electrode binder in at least one of the positive electrode and the negative electrode, it is possible to provide a lithium secondary battery capable of enhancing fast charging/discharging behavior efficiency of the electrode by reducing electrode resistance generated inside the electrode during charging/discharging.

### CROSS-REFERENCE TO RELATED APPLICATION

This application claims priority to and the benefit of Korean Patent Application No. 10-2021-0104198, filed on Aug. 6, 2021, in the Korean Intellectual Property Office, the disclosure of which is incorporated by reference herein in its entirety.

### BACKGROUND

### 1. Field

Embodiments of the present disclosure described herein related to an electrode binder for a lithium secondary battery, and an electrode and a lithium secondary battery, including the same.

### 2. Description of the Related Art

In recent years, along with eco-friendly energy and self-driving vehicles, interest and demand for electric vehicles are rapidly increasing. Lithium secondary batteries, due to their desirable characteristics, are expected to play a role as a key power source for electric vehicles in the future, and the technology pertinent thereto is rapidly advancing. A lithium secondary battery is a type (kind) of secondary battery that generates electrical energy through changes in chemical potential during intercalation-deintercalation of lithium ions. A lithium secondary battery includes a positive electrode, a negative electrode, a separator, and an electrolyte. Lithium secondary batteries have advantages of high capacity and operating voltage compared to other batteries, and thus are used in one or more suitable fields.

In lithium secondary batteries, lithium-containing metal oxides, such as LiCoO₂, LiMnO₂, LiMn₂O₄ and/or LiFePO₄, are used as positive electrode active materials. Negative electrode active materials include materials such as graphite, metal lithium, and/or silicon. Among these materials, carbon-based negative electrode active materials, such as graphite, exhibit little change in their crystal structure during the process of intercalation-deintercalation of lithium ions, thus exhibiting excellent or suitable service-life characteristics, and as such, were once used in the first commercialized lithium secondary batteries. Other than the active materials described above, the components in an electrode also include a conductive material and a binder. Among these components, the binder, despite the small portion it generally occupies in the composition inside an electrode, has a significant influence on slurry preparation, electrode casting, and stable electrochemical behavior, and as such, is regarded as an essential and critical component.

In the current battery industry, the binder widely used in carbon-based negative electrodes is a SBR (styrene-butadiene rubber)/CMC(carboxymethyl cellulose) heterogenous binder. CMC acts as a thickener that permits control over the viscosity of electrode slurry, and SBR serves to provide adhesion between materials, as well as between materials and current collectors inside an electrode. As described above, a binder may be an essential element inside the electrode, but because a binder itself is a polymer with low electrical conductivity and ionic conductivity, there is a disadvantage in that they act as resistance during charging/discharging of a battery. In particular, SBR i can contribute to a significant portion of internal electrode resistance. As the number of components acting as resistance inside a battery increases, the battery may be realized with a lower capacity than what could have been possible without such components, and this phenomenon becomes more apparent especially upon fast charging/discharging.

Accordingly, there is a need for research to reduce the electrode resistance caused by binders.

### SUMMARY

Aspects of embodiments of the present disclosure are directed toward an electrode binder for a lithium secondary battery, capable of enhancing fast charge/discharge behavior efficiency of an electrode by reducing electrode resistance generated inside the electrode upon charging/discharging.

Aspects of embodiments of the present disclosure are directed toward an electrode for a lithium secondary battery, the electrode including the binder.

Aspects of embodiments of the present disclosure are directed toward a lithium secondary battery including the electrode.

Additional aspects will be set forth in part in the description which follows and, in part, will be apparent from the description, or may be learned by practice of the presented embodiments of the disclosure.

According to an embodiment, an electrode binder for a lithium secondary battery includes: a cellulose-based graft polymer grafted with a compound having an ion-hopping site; and a polyacrylate-based polymer that has an anionic group by exchange with a cation.

According to an embodiment, an electrode for a lithium secondary battery includes: an electrode active material; and the electrode binder.

According to an embodiment, a lithium secondary battery includes: a positive electrode; a negative electrode; and a separator between the positive electrode and the negative electrode, wherein at least one of the positive electrode and the negative electrode includes the electrode binder.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 shows a synthesis scheme for a CMC-PEG polymer of Preparation Example 1 according to an embodiment of the present disclosure.

FIG. 2 shows, as an example of an electrode binder, complexation of two binders, a polyacrylate-based polymer (e.g., LiPAA) and a cellulose-based graft polymer (e.g., CMC-PEG) according to an embodiment of the present disclosure.

FIG. 3 shows the result of FT-IR analysis of a CMC-PEG synthesized in Preparation Example 1 before and after modification according to an embodiment of the present disclosure.

FIG. 4 shows the result of TGA analysis of a CMC-PEG synthesized in Preparation Example 1 before and after modification according to an embodiment of the present disclosure.

FIG. 5 shows the result of resistance measurement of Li/polymer membrane/Li symmetric cells for evaluation of ionic conductivity of CMC-PEG, LiPAA, CMC, and SBR polymers used as binders in Example 1 and Comparative Examples 1 to 4, respectively, according to an embodiment of the present disclosure.

FIG. 6A and FIG. 6B show the result of resistance measurement of SUS/polymer membrane/SUS symmetric cells for evaluation of ionic conductivity of CMC-PEG, LiPAA, CMC, and SBR polymers used as binders in Example 1 and Comparative Examples 1 to 4, respectively, according to an embodiment of the present disclosure.

FIG. 7 shows the result of evaluation of rate capability of the lithium secondary batteries prepared in Example 1 and Comparative Examples 1 to 4 according to an embodiment of the present disclosure.

FIG. 8 shows the result of EIS analysis after 50 charge-discharge cycles of the lithium secondary batteries prepared in Example 1 and Comparative Examples 1 to 4 according to an embodiment of the present disclosure.

FIG. 9 shows the result of analysis of electrode adhesion strength of the electrodes prepared in Example 1 and Comparative Examples 1 to 4.

FIG. 10 is a schematic diagram of a lithium secondary battery according to an example embodiment.

### DETAILED DESCRIPTION

Reference will now be made in more detail to embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described below, by referring to the drawings, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. For example, “at least one of a, b or c”, “at least one selected from among (e.g., selected from the group consisting of) a, b, and c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

The present disclosure of the present disclosure described below allows for one or more suitable changes and numerous embodiments, particular embodiments will be illustrated in the drawings and described in more detail in the detailed description. However, this is not intended to limit the present disclosure to particular modes of practice, and it is to be appreciated that all modifications, equivalents, and substitutes that do not depart from the spirit and technical scope of the present disclosure are encompassed in the present disclosure.

The terms used herein are merely used to describe particular embodiments, and are not intended to limit the present disclosure. An expression used in the singular encompasses the expression of the plural, unless it has a clearly different meaning in the context. As used herein below, it is to be understood that the terms such as “include”, “have”, and/or the like, are intended to indicate the existence of one or more features, numbers, operations, components, parts, elements, materials, or combinations thereof disclosed in the specification, and are not intended to preclude the possibility that one or more other features, numbers, operations, components, parts, elements, materials, or combinations thereof may exist or may be added. As used herein, the “/” may be interpreted as either “and” or “or” depending on situations.

In the attached drawings, the thicknesses of layers and regions may be exaggerated in size for clarity and are not shown to scale. Throughout the specification, like reference numerals are employed to denote like elements in the one or more suitable drawings of each drawing. Throughout the specification, when one element such as a layer, a film, a region, a plate, etc. is described as being “on” or “above” another element, it will be construed as either being directly on the other element or that intervening elements may be present between the elements. Throughout the specification, it will be understood that, although the terms first, second, etc. may be used herein to describe one or more suitable components, these components should not be limited by these terms. These terms are only used to distinguish one component from another.

The term “polymer” as used herein refers to a prepolymer, an oligomer, a homopolymer, a copolymer, and a blend or mixture thereof.

The phrase “a combination thereof” as used herein may refer to mixtures, copolymers, blends, alloys, composites, reaction products of constituents.

Hereinafter, an electrode binder for a lithium secondary battery, and an electrode and a lithium secondary battery including the same according to embodiments will be described in more detail.

In order to reduce electrode resistance by binders, the present inventors endeavored to increase stability of a polyacrylate-based polymer in slurry by substituting a linear polymer with a lithium cation while supplying a reversible lithium inventory and at the same time, substitute and modify a functional group capable of assisting faster lithium ion transport based on a hopping mechanism. Based on these studies, the present inventors have arrived at an electrode binder according to the present disclosure, which is capable of enhancing fast charge/discharge behavior efficiency of an electrode by reducing electrode resistance generated inside the electrode when charging/discharging.

According to an embodiment, an electrode binder for a lithium secondary battery includes: a cellulose-based graft copolymer in which a cellulose-based polymer is grafted with a compound having an ion-hopping site; a polyacrylate-based polymer having an anionic group by exchange with a cation.

The cellulose-based polymer is commonly used as a negative electrode binder, in particular, a carbon-based negative electrode binder such as graphite. The cellulose-based polymer is modified with a functional group capable of assisting lithium ion transport, and a linear polyacrylate-based polymer is subjected to cation exchange to form a polymer having an anionic group. A composite binder system using a combination of the two polymers thus obtained is capable of forming a three-dimensional network via noncovalent interactions, such as hydrogen bonds or ion-dipole interactions, and thus can enhance cohesive strength between particles, and can improve ionic conductivity through the modified functional group and anionic group.

Therefore, by introducing an electrode binder including the combination of the above two polymers, thereby making it possible to maintain a stable electrode structure and increase ionic conductivity inside the electrode, excellent or suitable electrochemical rate capability can be realized.

One of the two binders constituting the electrode binder for the lithium secondary battery is a cellulose-based graft copolymer having a cellulose-based polymer grafted with a compound having an ion-hopping site.

For example, the cellulose-based polymer may be selected from among methylcellulose, ethylcellulose, ethylmethylcellulose, hydroxyethylcellulose, hydroxypropylcellulose, methylhydroxyethylcellulose, ethylhydroxyethylcellulose, hydroxypropylmethylcellulose, carboxymethylcellulose, and derivatives thereof, or may be a combination thereof.

The compound having an ion-hopping site, to be grafted on the cellulose-based polymer, traps lithium ions and at the same time, permits efficient hopping of the trapped lithium ions, to thereby improve ionic conductivity. Such a compound having an ion-hopping site may have, as a functional group capable of trapping and hopping of lithium ions, an ion-hopping site selected from among an ether group, a carbonyl group, a nitrile group, or a combination thereof. Among these functional groups, a polymer having an ether group as the ion-hopping site may be preferable in that such a polymer can trap lithium ions, and at the same time, ether groups continuously arranged on the polymer chain permit a more efficient hopping of the trapped lithium ions.

According to one embodiment, the compound having an ion-hopping site may be a glycol-based polymer. For example, the compound having an ion-hopping site may be selected from among polyethylene glycol, polypropylene glycol, polybutylene glycol, and derivatives thereof, or a combination thereof. For example, the cellulose-based graft copolymer may be grafted by polyethylene glycol or a derivative thereof.

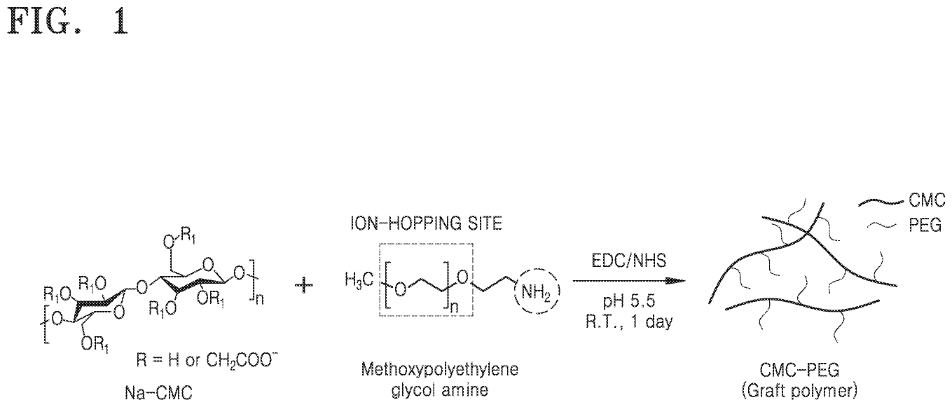

FIG. 1 is a synthesis scheme showing the synthesis process of a cellulose-based graft polymer according to an embodiment of the present disclosure.

Referring to FIG. 1, in a glycol-based compound such as methoxypolyethylene glycol amine, ethylene glycol repeat units serve as the ion-hopping site, and through a condensation reaction with a cellulose-based polymer (e.g., amine condensation reaction), the cellulose-based polymer can be grafted thereon.

With respect to the total weight of the cellulose-based graft copolymer, the content (e.g., amount) of the compound having an ion-hopping site may be about 5 wt % to about 70 wt %. With respect to the total weight of the cellulose-based graft copolymer, the content (e.g., amount) of the compound having an ion-hopping site may be, for example, about 10 wt % to about 65 wt %, about 20 wt % to about 60 wt %, or about 30 wt % to about 55 wt %. As the compound having an ion-hopping site is grafted in the above range, a cellulose-based graft copolymer relatively having high ionic conductivity (e.g., having suitable ionic conductivity) may be obtained.

The other one of the two types (kinds) of binders constituting the electrode binder for a lithium secondary battery may be a polyacrylate-based polymer that has an anionic group via an exchange with a cation.

The cation may be selected from among lithium ion, sodium ion, potassium ion, or a combination thereof. For example, the cation may be lithium ion. As such, by substituting the linear polyacrylate-based polymer with a cation, such as a lithium ion, it is possible to increase stability of the linear polyacrylate-based polymer in slurry and supply a reversible lithium inventory.

The polyacrylate-based polymer may include, but are not limited to, lithium polyacrylate, lithium polymethacrylate, sodium polyacrylate, sodium methacrylate, potassium polyacrylate, potassium methacrylate, or a combination thereof.

Non-covalent interactions may act to form a 3-dimensional network between the cellulose-based graft polymer and the polyacrylate-based polymer, thereby enhancing cohesive strength between particles, and ionic conductivity may be improved through the modified functional group and anionic group. The non-covalent interactions may be at least one selected from among a hydrogen bond, an ion-dipole interaction, and a hydrophobic interaction (e.g., at least one of the hydrogen bond, the ion-dipole interaction, or the hydrophobic interaction).

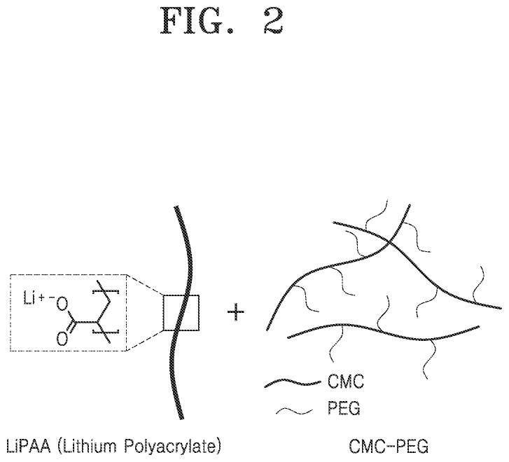

FIG. 2 shows an example of an electrode binder, wherein upon complexation of two types (kinds) of binders, a polyacrylate-based polymer (e.g., LiPAA) and a cellulose-based graft polymer (e.g., CMC-PEG), there may be hydrogen bonds, ion-dipole interactions, etc. may be present between carboxylate and hydroxide groups according to an embodiment of the present disclosure.

Inside the electrode binder for a lithium secondary battery, the weight ratio of the cellulose-based graft polymer and the polyacrylate-based polymer may be in a range of about 5:95 to about 95:5. For example, the weight ratio of the cellulose-based graft polymer and the polyacrylate-based polymer may be in the range of about 10:90 to about 90:10, about 20:80 to about 80:20, about 25:75 to about 75:25, about 30:70 to about 70:30, about 35:65 to about 65:35, about 40:60 to about 60:40, or about 45:55 to about 55:45. In the above range, non-covalent interactions may effectively occur between the cellulose-based graft polymer and the polyacrylate-based polymer.

The electrode for a lithium secondary battery according to another embodiment may include an electrode active material and the above-described electrode binder.

According to one example, the electrode active material may be a negative electrode active material, and for example, may be a carbonaceous negative electrode active material.

The carbonaceous negative electrode active material may include a crystalline carbon, an amorphous carbon, or a mixture thereof. For example, the carbonaceous negative electrode active material may include at least one selected from among artificial graphite, natural graphite, a graphitized carbon fiber, a graphitized mesocarbon microbead, a petroleum coke, a plastic resin, a carbon fiber, and a pyrolytic carbon.

With respect to the total weight of the electrode active material and the electrode binder, the content (e.g., amount) of the electrode active material may be about 80 wt % to about 99.9 wt %, and the content (e.g., amount) of the electrode binder may be about 0.1 wt % to about 20 wt %. For example, with respect to the total weight of the electrode active material and the electrode binder, the content (e.g., amount) of the electrode active material may be about 85 wt % to about 99 wt %, and the content (e.g., amount) of the electrode binder may be about 1 wt % to about 15 wt %. For example, with respect to the total weight of the electrode active material and the electrode binder, the content (e.g., amount) of the electrode active material may be about 90 wt % to about 99 wt %, and the content (e.g., amount) of the electrode binder may be about 1 wt % to about 10 wt %. Despite containing such a low content (e.g., amount) of the electrode binder in the above range, an electrode with excellent or suitable cohesion between electrode particles and between current collectors may be obtained.

A lithium secondary battery according to another embodiment may include a positive electrode, a negative electrode, and a separator placed between the positive electrode and the negative electrode, wherein at least one of the positive electrode and the negative electrode may include the above-described electrode binder.

According to one example, the electrode binder may be included in the negative electrode. The electrode binder may be included in the positive electrode, and may be included in both (e.g., simultaneously) the positive electrode and the negative electrode.

The lithium secondary battery may be prepared, for example, by the method described herein.

First, there may be prepared a negative electrode active material composition containing a mixture of a negative electrode active material, a conductive material, a binder, and a solvent. The negative electrode active material composition may be directly coated onto a negative electrode current collector to thereby form a negative electrode. In some embodiments, the negative electrode active material composition may be cast on a separate support, and a film exfoliated from the support may be laminated on a negative electrode current collector to thereby form a negative electrode. The negative electrode is not limited to the above-mentioned forms, but may be another form other than the above-mentioned forms.

The negative electrode active material may be a carbonaceous material. The carbonaceous material may be, for example, a crystalline carbon, an amorphous carbon, or a mixture thereof. The crystalline carbon may include graphite, such as natural graphite or artificial graphite that are in non-shaped, plate, flake, spherical or fibrous form, graphitized carbon fiber, and graphitized mesocarbon microbeads. The amorphous carbon may include soft carbon (e.g., low-temperature sintered carbon), hard carbon, mesophase pitch carbides, sintered petroleum cokes, plastic resin, carbon fiber, pyrolytic carbon, and/or the like.

The negative electrode active material may be a composite of the carbonaceous material and a non-carbonaceous material, and may further include a non-carbonaceous material in addition to the carbonaceous material.

Examples of the non-carbonaceous may include one or more selected from the group consisting of a metal alloyable with lithium, an alloy of a metal alloyable with lithium, and an oxide of a metal alloyable with lithium.

Examples of the metal alloyable with lithium may include Si, Sn, Al, Ge, Pb, Bi, Sb, a Si—Y alloy (wherein Y is an alkali metal, an alkaline earth metal, a Group 13-16 element, a transition metal, a rare earth metal, or a combination thereof, but not Si), a Sn—Y alloy (wherein Y is an alkali metal, an alkaline earth metal, a Group 13-16 element, a transition metal, a rare earth metal, or a combination thereof, but not Sn) and/or the like. Element Y may be Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

For example, the transition metal oxide may be a lithium titanium oxide, a vanadium oxide, a lithium vanadium oxide, and/or the like.

For example, the non-transition metal oxide may be SnO₂, SiOₓ (0<x<2), and/or the like.

In particular, the negative electrode active material may be, but is not limited to, one or more selected from the group consisting of Si, Sn, Pb, Ge, Al, SiOₓ (0<x≤2), SnOy (0<y≤2), Li₄Ti₅O₁₂, TiO₂, LiTiO₃, and Li₂Ti₃O₇, and may be any material that is used as a negative electrode active material in the art.

For example, the negative electrode active material may be a silicon-based active material. In particular, the silicon-based active material may include silicon, a silicon-carbon complex, SiOₓ (0<x<2), an Si-Q alloy (Q is an element selected from the group consisting of alkali metals, alkaline earth metals, elements of Group 13, elements of Group 14, elements of Group 15, elements of Group 16, transition metals, rare-earth elements, or a combination thereof, but not Si), or a combination thereof. In some embodiments, at least one of the aforementioned components may be mixed with SiO₂ and used as the silicon-based active material. Element Q may be selected from the group consisting of Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and combinations thereof.

The silicon-based active material may include, as one example, a silicon-carbon complex containing silicon particles and a first carbonaceous material. Here, the first carbonaceous material may be a crystalline carbon, an amorphous carbon, or a combination thereof. Using such a silicon-carbon complex as the silicon-based active material may realize stable cycling characteristics and high capacity concurrently (e.g., simultaneously).

In the silicon-carbon complex containing the silicon particles and the first carbonaceous material, the content (e.g., amount) of the silicon particles may be about 30 wt % to about 70 wt %, and for example, may be about 40 wt % to about 50 wt %. The content (e.g., amount) of the first carbonaceous material may be about 70 wt % to about 30 wt %, and for example, may be about 50 wt % to about 60 wt %. When the content (e.g., amount) of the silicon particles and the first carbonaceous material is within the above range, it is possible to realize both excellent or suitable lifetime characteristics and high-capacity characteristics concurrently (e.g., simultaneously).

Also, the silicon-based active material may include a silicon-carbon complex containing a core and a third carbonaceous material around (e.g., surrounding) the core, wherein the core contains a mixture of silicon particles and a second carbonaceous material. Such a silicon-carbon complex can realize extremely high capacity, and at the same time, improve capacity retention rate and high-temperature lifetime characteristics of the battery.

Here, the third carbonaceous material may be present in a thickness of about 5 nm to about 100 nm. In some embodiments, with respect to about 100 wt % of the silicon-carbon complex, the third carbonaceous material may be included in an amount of about 1 wt % to about 50 wt %, the silicon particles may be included in an amount of about 30 wt % to about 70 wt %, and the second carbonaceous material may be included in an amount of about 20 wt % to about 69 wt %. Silicon particles, third carbonaceous material, and second carbonaceous material in the amounts in the respective ranges above may realize excellent or suitable discharge capacity while improving capacity retention rate, and thus may be preferable.

The silicon particles may have a particle diameter of about 10 nm to about 30 μm, and for example, may be about 10 nm to about 1,000 nm, or 20 nm to about 150 nm. When the average particle diameter of the silicon particles is within the above range, it is possible to suppress or reduce volume expansion during charge/discharge and prevent or reduce discontinuation of electron transport due to disintegration of particles during charging/discharging.

In the silicon-carbon complex, for example, the second carbonaceous material may be a crystalline carbon, and the third carbonaceous material may be an amorphous carbon. For example, the silicon-carbon complex may be a silicon-carbon complex that includes a core containing silicon particles and a crystalline carbon, and an amorphous carbon coating layer positioned on the surface of the core.

The crystalline carbon may include artificial graphite, natural graphite, or a combination thereof. The amorphous carbon may include pitch carbon, soft carbon, hard carbon, mesophase pitch carbides, calcined coke, carbon fibers, or a combination thereof. A precursor of the amorphous carbon may be coal-based pitch, mesophase pitch, petroleum-based pitch, coal-based oil, petroleum heavy oil, or polymer resin such as phenolic resin, furan resin, polyimide resin, and/or the like.

The silicon-carbon complex may include, with respect to 100 wt % of the silicon-carbon complex, about 10 wt % to about 60 wt % of silicon, and about 40 wt % to about 90 wt % of a carbonaceous material. In some embodiments, in the silicon-carbon complex, the content (e.g., amount) of the crystalline carbon may be, with respect to the total weight of the silicon-carbon complex, about 10 wt % to about 70 wt %, and the content (e.g., amount) of the amorphous carbon may be about 20 wt % to about 40 wt %.

The silicon particles may be in an oxidized form, and here, an Si:O atom content (e.g., amount) ratio in silicon particles, representing the state of oxidation, may be about 99:1 to about 33:66 in weight ratio. The silicon particles may be SiOₓ particles, and here, the range of x in SiOₓ may be greater than 0, and less than 2. Here, unless otherwise defined, the average particle diameter (D50) refers to a diameter of the particles at cumulative volume of 50 vol %.

The negative electrode may further include a conductive material. Examples of the conductive material may include, but are not limited to, acetylene black, Ketjen black, natural graphite, artificial graphite, carbon black, acetylene black, Ketjen black, carbon fiber, and metal powder and metal fiber of copper, nickel, aluminum, silver, and/or the like. The conductive material may be one type or kind of, or a mixture of one or more types (kinds) of conductive materials such as polyphenylene derivatives and/or the like. The conductive material may be any material that is usable as conductive material in the art. In some embodiments, the above-described crystalline carbonaceous material may be added as a conductive material.

For the binder, an electrode binder according to one embodiment may be included.

The negative electrode may further include a conventional binder in addition to the above-described electrode binder. Examples of the conventional binder include, but are not strictly limited to, polyvinylidene fluoride, polyvinylidene chloride, polybenzimidazole, polyimide, polyvinyl acetate, polyvinyl alcohol, carboxymethyl cellulose (CMC), starch, hydroxypropyl cellulose, regenerated cellulose, polyvinylpyrrolidone, tetrafluoroethylene, polyethylene, polypropylene, polystyrene, polyaniline, acrylonitrile butadiene styrene, phenolic resin, epoxy resin, polyethylene terephthalate, polytetrafluoroethylene, polyphenylsulfide, polyamideimide, polyetherimide, polyethylene sulfone, polyamide, polyacetal, polyphenylene oxide, polybutylene terephthalate, ethylene-propylene-dien terpolymer (EPDM), sulfonated EPDM, styrene butadiene rubber (SBR), flourorubber, and one or more suitable copolymers. The suitable binder may be any suitable material that is used as a negative electrode binder in the art.

For the solvent, N-methylpyrrolidone, acetone, water, etc. may be used, but the solvent is not limited thereto and may be any solvent that is usable in the art.

The respective amounts of the negative electrode active material, the conductive material, the binder, and the solvent are at a level commonly or suitably used in lithium batteries. One or more of the conductive material, the binder, and the solvent may be absent depending on the use and composition of the lithium secondary battery.

The negative electrode current collector may have a thickness of about 3 μm to about 100 μm, for example. The negative electrode current collector is not limited to any particular material and may be any material that has high conductivity and causes no chemical changes to a lithium battery. For example, copper, stainless steel, aluminum, nickel, titanium, calcined carbon, or copper or stainless steel that is surface-coated with carbon, nickel, titanium, silver, etc., may be used. The negative electrode current collector may have binding strength of the negative active material increased by forming minute irregularities on a surface of the current collector, and may be in one or more suitable forms such as a film, a sheet, a foil, a net, a porous body, a foaming body, and/or a non-woven fabric. The negative electrode current collector may be, in particular, a copper foil.

The thickness of the negative electrode including the negative electrode current collector and negative electrode active material layer may be for example, about 3 μm to about 200 μm, about 10 μm to about 180 μm, about 20 μm to about 150 μm, or about 30 μm to about 120 μm.

Next, there may be prepared a positive electrode active material composition containing a mixture of a positive electrode active material, a conductive material, a binder, and a solvent. The positive electrode active material composition may be directly coated and dried on a positive electrode current collector to thereby form a positive electrode. In some embodiments, the positive electrode active material composition may be cast on a separate support, and a film exfoliated from the support may be laminated on a positive electrode current collector to thereby form a positive electrode.

The positive electrode active material may include at least one selected from the group consisting of lithium cobalt oxide, lithium nickel cobalt manganese oxide, lithium nickel cobalt aluminum oxide, lithium iron phosphate, and lithium manganese oxide. However, the positive electrode active material is not strictly limited to the aforementioned components and may include any positive electrode active material usable or suitable in the art.

For example, the positive electrode active material may be a compound represented by any one of the following chemical formulas: LiaA_{1-b}B_{b}D₂ (in the formula, 0.90≤a≤1.8 and 0≤b≤0.5); LiaE_{1-b}B_{b}O_{2-c}D_{c} (in the formula, 0.90≤a≤1.8, 0≤b≤0.5, 0≤c≤0.05); LiE_{2-b}B_{b}O_{4-c}D_{c} (in the formula, 0≤b≤0.5, 0≤c≤0.05); LiₐNi_{1-b-c}Co_{b}B_{c}D_{α}(in the formula, 0.90≤a≤1.8, 0≤b≤0.5, 0≤c≤0.05, 0<α≤2); LiₐNi_{1-b-c}Co_{b}B_{c}O_{2-α}F_{α}(in the formula, 0.90≤a≤1.8, 0≤b≤0.5, 0≤c≤0.05, 0<α<2); LiₐNi_{1-b-c}Co_{b}B_{c}O_{2-α}F₂ (in the formula, 0.90≤a≤1.8, 0≤b≤0.5, 0≤c≤0.05, 0<α<2); LiₐNi_{1-b-c}Mn_{b}B_{c}D_{α}(in the formula, 0.90≤a≤1.8, 0≤b≤0.5, 0≤c≤0.05, 0<α≤2); LiₐNi_{1-b-c}Mn_{b}B_{c}O_{2-α}F_{α}(in the formula, 0.90≤a≤1.8, 0≤b≤0.5, 0≤c≤0.05, 0<α<2); LiₐNi_{1-b-c}Mn_{b}B_{c}O_{2-α}F₂ (in the formula, 0.90≤a≤1.8, 0≤b≤0.5, 0≤c≤0.05, 0<α<2); LiₐNi_{b}E_{c}G_{d}O₂ (in the formula, 0.90≤a≤1.8, 0≤b≤0.9, 0≤c≤0.5, 0.001≤d≤0.1); LiₐNi_{b}Co_{c}Mn_{d}GeO₂ (in the formula, 0.90≤a≤1.8, 0≤b≤0.9, 0≤c≤0.5, 0≤d≤0.5, 0.001≤e≤0.1); LiₐNiG_{b}O₂ (in the formula, 0.90≤a≤1.8, 0.001≤b≤0.1); LiₐCoG_{b}O₂ (in the formula, 0.90≤a≤1.8, 0.001≤b≤0.1); LiₐMnG_{b}O₂ (in the formula, 0.90≤a≤1.8, 0.001≤b≤0.1); LiₐMn₂G_{b}O₄ (in the formula, 0.90≤a≤1.8, 0.001≤b≤0.1); QO₂; QS₂; LiQS₂; V₂O₅; LiV₂O₅; LiIO₂; LiNiVO₄; Li_{(3-f)}J₂(PO₄)₃(0≤f≤2); Li_{(3-F)}FE₂(PO₄)₃(0≤f≤2); and LiFePO₄.

In these formulas, A is Ni, Co, Mn, or a combination thereof; B is Al, Ni, Co, Mn, Cr, Fe, Mg, Sr, V, a rare-earth element, or a combination thereof; D is O, F, S, P, or a combination thereof; E is Co, Mn, or a combination thereof; F is fluorine (F), S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

Needless to say, any of the aforementioned compounds that has a coating layer on the surface thereof, or a mixture of any one of the aforementioned compounds with the compound having a coating layer may also be used. Such a coating layer may include a coating element compound of an oxide and a hydroxide of a coating element, oxyhydroxide of a coating element, an oxycarbonate of a coating element, or a hydroxycarbonate of a coating element. The compound forming such a coating layer may be amorphous or crystalline. The coating element included in the coating layer may be Mg, Al, Co, K, Na, Ca, Si, Ti, V, Sn, Ge, Ga, B, As, Zr, or a mixture thereof. For the process of forming the coating layer, any suitable coating method that is capable of coating the above compound by using such elements, without adversely affecting the physical properties of positive electrode active material may be used without limitation (e.g., spray coating, precipitation, etc.), and because such methods are commonly understood by those skilled in the art, and therefore will not be described in further detail.

For example, LiNiO₂, LiCoO₂, LiMnₓO₂ₓ(x=1, 2), LiNi₁₋ₓMnₓO₂(0<x<1), LiNi_{1-x-y}CoₓMn_{y}O₂(0≤x≤0.5, 0≤y≤0.5), LiFeO₂, V₂O₅, TiS, MoS, and/or the like, may be used.

The positive electrode active material composition may utilize the same conductive material, binder and solvent as used in the negative electrode active material composition above. Also, a plasticizer may be further added to the positive electrode active material composition and/or negative electrode active material composition to form pores within the electrode plate.

The respective amounts of the positive electrode active material, conductive material, binder, and solvent are at a level commonly or suitably used in lithium batteries. One or more selected from amoung the conductive material, general binder, and solvent may be excluded depending on the use and composition of the lithium secondary battery.

In some embodiments, the binder used in the preparation of the positive electrode may be the same binder included in the negative electrode.

Next, a separator to be placed between the positive electrode and the negative electrode may be prepared.

The separator may be any separator that is commonly or suitably used in lithium batteries. Any suitable separator capable of retaining a large quantity of electrolyte solution while exhibiting low resistance to ion migration in electrolyte may be used. For example, the separator may be selected from among glass fiber, polyester, Teflon, polyethylene, polypropylene, polytetrafluoroethylene (PTFE), and/or a combination thereof. In some embodiments, the separator is generally in the form of nonwoven fabric but can be in the form of woven fabric. A lithium ion battery includes, for example, a rollable separator formed of polyethylene, polypropylene, and/or the like. A lithium ion polymer battery includes for example, a separator having an excellent or suitable electrolyte retention capability.

The separator may be prepared by the following method as an example.

A separator composition may be prepared by mixing a polymer resin, a filler, and a solvent. The separator composition may be, for example, directly coated and dried on top of an electrode to thereby form the separator. In some embodiments, the separator composition may be cast and dried on a support, and a separator film exfoliated from the support may be laminated on top of an electrode, to thereby form the separator. The polymer resin used in the separator preparation is not particularly limited, and may utilize any material that is used as a binder in electrodes. Examples of the polymer resin used in the separator preparation include a vinylidenefluoride/hexafluoropropylene copolymer, polyvinylidenefluoride (PVDF), polyacrylonitrile, polymethylmethacrylate, or mixtures thereof, and/or the like.

Next, an electrolyte to be placed between the positive electrode and the negative electrode may be prepared.

The electrolyte may be in a liquid or gel state.

For example, the electrolyte may be an organic electrolyte solution. Also, the electrolyte may be solid. For example, the electrolyte may be, but is not limited to, a boron oxide, lithium oxynitride, and/or the like, and may be any material that can be used as a solid electrolyte in the art. The solid electrolyte may be formed on the negative electrode by methods such as sputtering and/or the like.

For example, the organic electrolyte solution may be prepared. The organic electrolyte solution may be prepared by dissolving a lithium salt in an organic solvent.

The organic solvent may be any material that can be used as an organic solvent in the art. Examples of the organic solvent may include propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, and mixtures thereof.

The lithium salt may be any material that can be used as a lithium salt in the art. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAICl₄, LiN(CₓF₂ₓ₊₁SO₂)(C_{y}F_{2y+1}SO₂) (wherein x and y are natural numbers), LiCl, LiI or a mixture thereof.

The electrolyte may be, for example, a solid electrolyte. The solid electrolyte may be, for example, a polymer solid electrolyte. Examples of the polymer solid electrolyte include polyethylene derivatives, polyethylene oxide derivatives, polypropylene oxide derivatives, phosphoric acid ester polymers, polyester sulfide, polyvinyl alcohol, polyvinylidene fluoride, polymers containing an ionic dissociable group, and/or the like. For example, the solid electrolyte may be an inorganic solid electrolyte. Examples of the inorganic solid electrolyte include Li₃N, LiI, Li₅NI₂, Li₃N—LiI—LiOH, LiSiO₄, Li₂SiS₃, Li₄SiO₄, Li₄SiO₄—LiI—LiOH, Li₃PO₄—Li₂S—SiS₂, and/or the like.

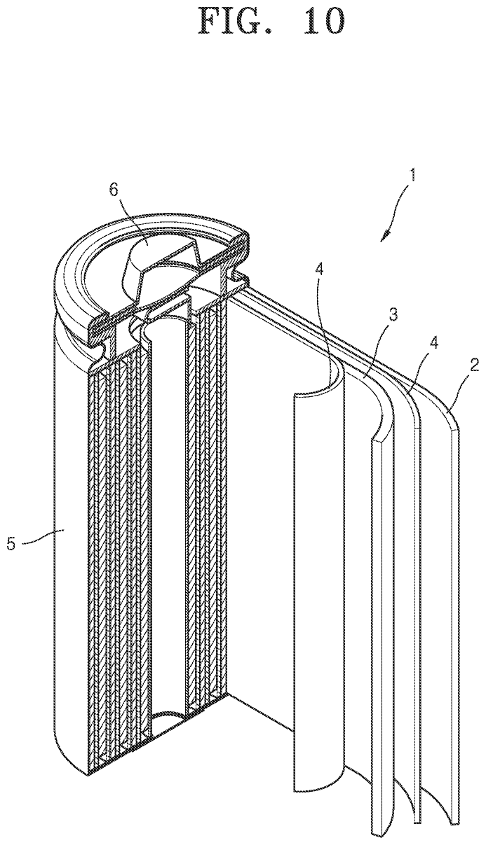

Referring to FIG. 10, a lithium secondary battery (1) includes a positive electrode (3), a negative electrode (2), and a separator (4). The positive electrode (3), the negative electrode (2), and the separator (4) may be wound or folded so as to be accommodated a battery case (5). Subsequently, the battery case (5) may be injected with electrolyte and sealed with a cap assembly (6), thereby completing the lithium battery (1). The battery case may be, for example, a pouch type or kind, a cylindrical type or kind, a rectangular type or kind, a thin-film type or kind, and/or the like.

The lithium secondary battery may have the separator placed between the positive electrode and the negative electrode to thereby form a battery structure. The battery structure may be laminated in a bi-cell structure and immersed in electrolyte, and then the resulting product may be accommodated and sealed in a pouch, to thereby complete a lithium-ion polymer battery. Also, multiple units of the battery structure may be stacked to thereby form a battery pack. The battery pack may be used in devices that require high capacity and high output. For example, the battery pack may be used in a laptop computer, a smartphone, an electric vehicle, and/or the like.

The lithium secondary battery may be used, for example, in power tools operated by electric motors; electric vehicles including an electric vehicle (EV), a hybrid electric vehicle (HEV), a plug-in hybrid electric vehicle (PHEV), and/or the like; electric two-wheeled vehicles including an electric bicycle (E-bike), an electric scooter (Escooter), and/or the like; an electric golf cart; and power storage systems and/or the like, but is not limited thereto.

The following examples and comparative examples are provided to describe the present disclosure in greater detail. However, it will be understood that the examples are provided only to illustrate the present disclosure and not to be construed as limiting the scope of the present disclosure.

### Preparation of Binder

### Preparation Example 1: Synthesis of CMC-Poly Ethylene Glycol (CMC-PEG) Polymer

Following the reaction scheme illustrated in FIG. 1, a CMC-PEG polymer was synthesized as follows.

50 mM 4-morpholine ethanesulfonic acid (MES) buffer solution (pH 5.5) was prepared. 1 wt % CMC solution was prepared by dissolving 0.2 g of sodium carboxymethylcellulose in the MES buffer solution. Subsequently, 0.039 g of N-hydroxysuccinimide (NHS) and 0.128 g of 1-ethyl-3-(3-dimethylaminopropyl) carbodiimide (EDC) were introduced in the CMC solution and subjected to stirring at room temperature for 2 hours.

Next, 0.25 g of methoxypolyethylene glycol amine was added to the above solution and subjected to stirring at room temperature for one day.

The resulting product was subjected to dialysis under stirring using water, at room temperature over two days. Then, the resulting product was freeze-dried, and CMC-PEG polymers were obtained therefrom.

### Preparation Example 2: Synthesis of Lithium Polyacrylate (LiPAA) Polymer

5 wt % PAA solution was prepared by dissolving polyacrylic acid (PAA) (Mw=450,000) in H₂O. Lithium hydroxide (LiOH) in an equivalence ratio of 1:1 with respect to PAA was added to the PAA solution and subjected to stirring at room temperature for one day.

The resulting product was subjected to dialysis under stirring using water, at room temperature over two days. Then, the resulting product was freeze-dried, and LiPAA polymers were obtained therefrom.

### Preparation of Lithium Secondary Battery

### Example 1

As an active material, graphite and a binder were prepared in a weight ratio of 97.5:2.5. For the binder, the CMC-PEG synthesized in Preparation Example 1 and the LiPPA synthesized in Preparation Example 2 were prepared in a weight ratio of 1:1.5.

1 wt % aqueous solution of the CMC-PEG was added to the graphite over two additions, and after each addition, was uniformly dispersed using a THINKY mixer for 3 minutes. Then, after adding 10 wt % aqueous solution of the LiPAA, substantially uniform dispersion was ensured by using a THINKY mixer for 3 minutes, to thereby produce an electrode slurry.

The electrode slurry thus produced was cast on a copper current collector, and dried for 10 minutes at 110° C. under atmospheric pressure, and then dried in a 60° C. vacuum oven over one day, to thereby produce an electrode.

Using the electrode thus produced, and lithium metal as a counter electrode, and using a PTFE separator, and as electrolyte, a solution in which 1M LiPF₆ and 10 wt % fluoroethylene carbonate (FEC) are dissolved in EC (ethylene carbonate) and DEC (diethyl carbonate) (1:1 volume ratio), a coin half cell was prepared.

### Comparative Example 1

A coin half cell was prepared following the same process as Example 1, except that the electrode slurry used was prepared as follows: CMC and styrene-butadiene rubber (SBR) were prepared in a weight ratio of 1:1.5 as the binder, and 1 wt % aqueous solution of CMC was added to graphite over two additions, and after each addition, was uniformly dispersed using a THINKY mixer for 3 minutes, and then after adding 40 wt % aqueous solution of SBR, substantially uniform dispersion was ensured using a THINKY mixer for 1 minute, to produce the electrode slurry.

### Comparative Example 2

A coin half cell was prepared following the same process as Example 1, except that the electrode slurry used was prepared as follows: the CMC-PEG synthesized in Preparation Example 1 and SBR were prepared in a weight ratio of 1:1.5 as the binder, and 1 wt % aqueous solution of the CMC-PEG was added to graphite over two additions, and after each addition, was uniformly dispersed using a THINKY mixer for 3 minutes, and then after adding 40 wt % aqueous solution of SBR, substantially uniform dispersion was ensured using a THINKY mixer for 1 minute, to produce the electrode slurry.

### Comparative Example 3

A coin half cell was prepared following the same process as Example 1, except that the electrode slurry used was prepared as follows: CMC and the LiPAA synthesized in Preparation Example 2 were prepared in a weight ratio of 1:1.5 as the binder, and 10 wt % aqueous solution of the LiPAA was added to graphite and uniformly dispersed using a THINKY mixer for 3 minutes, and then after adding 40 wt % aqueous solution of SBR, substantially uniform dispersion was ensured using a THINKY mixer for 1 minute, to produce the electrode slurry.

### Comparative Example 4

A coin half cell was prepared following the same process as Example 1, except that the electrode slurry used was prepared as follows: SBR and the LiPAA synthesized in Preparation Example 2 were prepared in a weight ratio of 1.5:1 as the binder, and 1 wt % aqueous solution of CMC was added to graphite over two additions, and after each addition, was uniformly dispersed using a THINKY mixer for 3 minutes, and then after adding 10 wt % aqueous solution of the LiPAA, substantially uniform dispersion was ensured using a THINKY mixer for 1 minute, to produce the electrode slurry.

### Evaluation Example 1: Analysis of Result of Modification of CMC-PEG

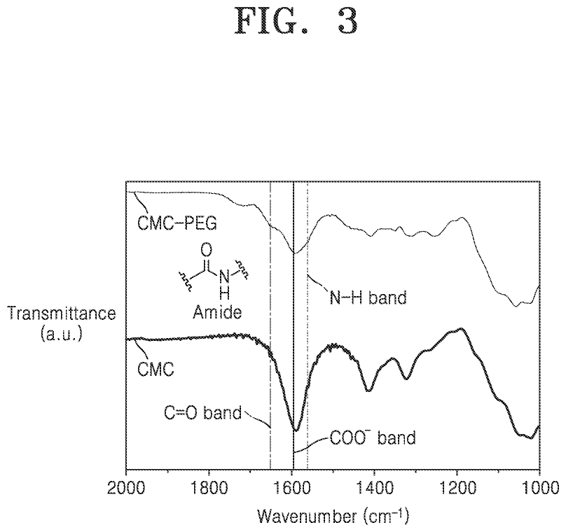

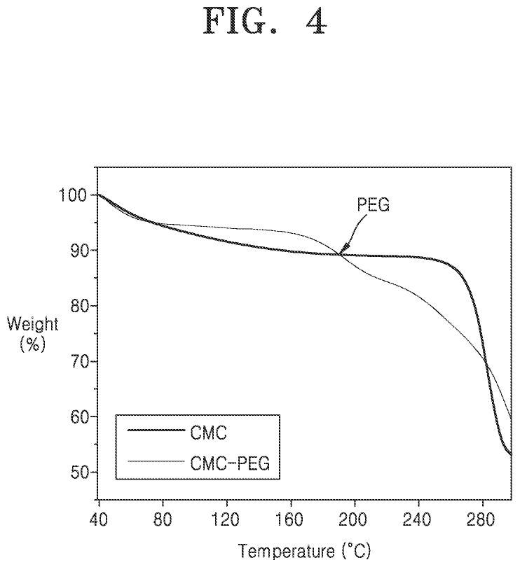

To analyze the result of modification of the CMC-PEG synthesized in Preparation Example 1, the CMC-PEG and CMC prior to modification were subjected to FT-IR analysis and TGA analysis, and the results thereof are shown in FIG. 3 and FIG. 4, respectively.

As shown in FIG. 3, it could be seen that while the CMC-PEG shows a band indicating amide bonding due to reactions between methoxypolyethylene glycol amine and the carboxyl group of CMC, the CMC exhibits no such amide band.

As shown in FIG. 4, the CMC-PEG shows a weight decrease starting from about 165° C. and up to about 265° C., which should be attributable to thermal decomposition of PEG, and subsequently from here, the CMC-PEG and the CMC both (e.g., simultaneously) undergo thermal decomposition of CMC.

### Evaluation Example 2: Measurement of Membrane Ion Conductivity

To evaluate ionic conductivity of the respective polymers used as binders in Example 1 and Comparative Examples 1 to 4, CMC-PEG, LiPAA, CMC, and SBR, a polymer membrane and a symmetric cell were prepared as follows.

First, using a 18 pi-sized filter paper as a support, 50 μL of 1 wt % solution containing each of the polymers was injected by using a dip coating method on the filter paper, and dried in a 60° C. oven over one day, to produce polymer membranes.

Symmetric cells having Li metal placed at both sides with respect to each polymer membrane, and symmetric cells having stainless steel placed on both sides of the polymer membrane, were prepared. Each polymer membrane obtained through drying was used in place of a separator, and 10 μL of the same electrolyte used in the preparation of the coin half cell above was added to complete the symmetric cells.

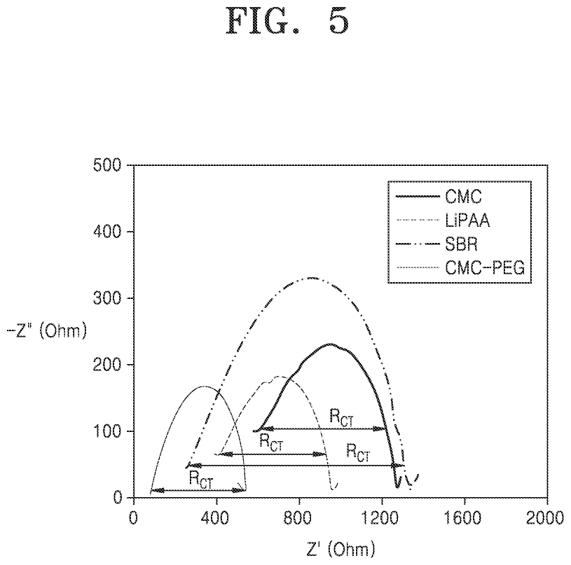

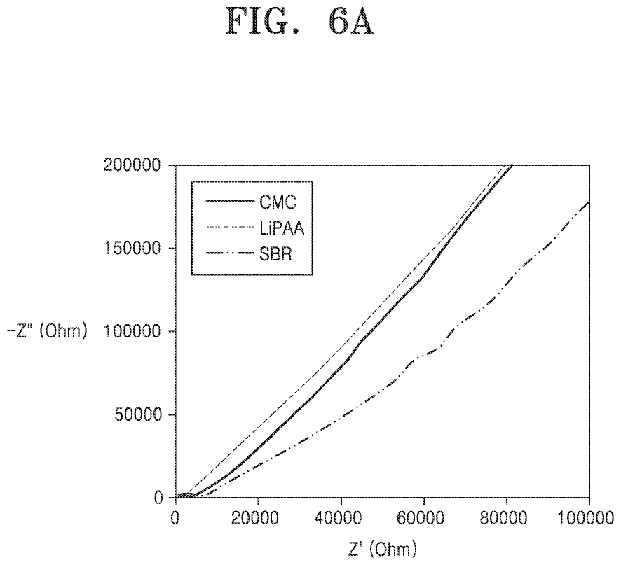

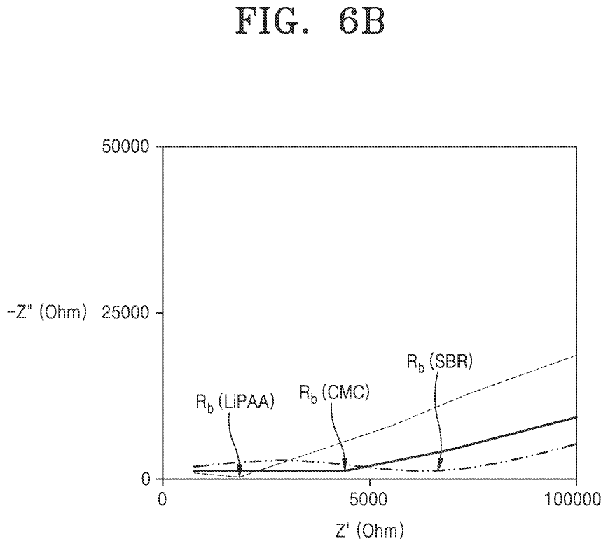

The result of resistance measurement of Li/polymer membrane/Li symmetric cells, made by electrochemical impedance spectroscopy (EIS) using VSP Potentiostat equipment (BioLogic), is shown in FIG. 5, and the result of resistance measurement of SUS/polymer membrane/SUS symmetric cells is shown in FIG. 6A and FIG. 6B.

As shown in FIG. 5 and FIGS. 6A-6B, the CMC-PEG and LiPAA polymer membranes show a lower resistance than that of CMC and SBR. Accordingly, in terms of the membrane ion conductivity of each of the respective polymers, CMC-PEG showed the highest ion conductivity, LiPAA showed a similar level of ion conductivity as CMC-PEG, and the ionic conductivity further decreased in the order of CMC>SBR (e.g., membrane ion conductivity: CMC-PEG≈LiPAA>CMC>SBR).

From this result, it is possible to predict that using a combination of CMC-PEG and LiPAA as a binder can maximize or increase ionic conductivity.

### Evaluation Example 3: Evaluation of Rate Capability

The lithium secondary batteries prepared in Example 1 and Comparative Examples 1 to 4 were evaluated for rate capability by the following method.

The coin half cells prepared in Example 1 and Comparative Examples 1 to 4 were pre-cycled at 0.1 C, and then for every 3 cycles increase, sequentially changed to 0.1 C, 0.2 C, 0.5 C, 1.0 C, and 2.0 C.

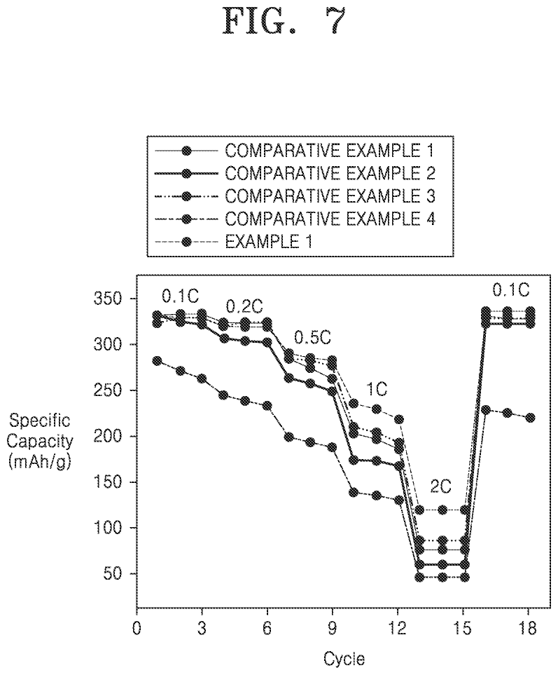

The result of rate capability evaluation for each coin half cell is shown in FIG. 7. In some embodiments, discharge capacity at 1 C as a representative example is shown in Table 1.

As shown in FIG. 7 and Table 1, Example 1 including both CMC-PEG and LiPAA shows mitigated capacity decrease over C-rate changes, and shows improved rate capability.

### Evaluation Example 3: EIS Analysis Evaluation

The lithium secondary batteries prepared in Example 1 and Comparative Examples 1 to 4 were analyzed for interfacial resistance in the electrode by EIS measurement.

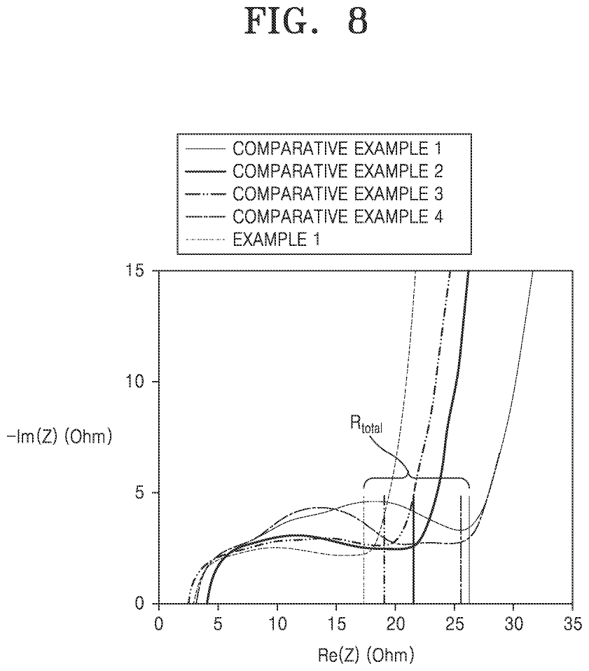

Each lithium secondary battery was pre-cycled at 0.1 C and charged-discharged through 50 cycles at 0.5 C before EIS analysis. The result of EIS analysis is shown in FIG. 8.

In FIG. 8, the interfacial resistance of an electrode is determined by the location and size of half circle extending downward from the curve. The difference between the left x-intercept and the right x-intercept in half circle extending downward from the curve represents the interfacial resistance in an electrode. Interfacial resistances of the electrodes are shown in Table 1.

TABLE 1

| | | | 1 C Discharge |
|---|---|---|---|
| | | Rₜₒₜₐₗ | Capacity |
| | Binder Composition | (Ω) | (mAh g⁻¹) |
| Comparative | CMC:SBR | 24.98 | 195.02 |
| Example 1 | 1:1.5 | | |
| Comparative | CMC-PEG:SBR | 20.38 | 171.96 |
| Example 2 | 1:1.5 | | |
| Comparative | CMC:LiPAA | 18.98 | 201.96 |
| Example 3 | 1:1.5 | | |
| Comparative | SBR:LiPAA | 24.72 | 134.67 |
| Example 4 | 1.5:1 | | |
| Example 1 | CMC-PEG:LiPAA | 16.74 | 228.8 |
| | 1:1.5 | | |

As shown in Table 1, the lithium secondary battery of Example 1, containing both (e.g., simultaneously) CMC-PEG and LiPAA, showed a smaller total interfacial resistance after 50 cycles compared to Comparative Examples 1 to 4.

### Evaluation Example 4: Analysis of Electrode Adhesion Strength for Different Types of Binders

Electrode adhesion test was performed on the electrodes prepared in Example 1 and Comparative Examples 1 to 4. The surface of each of the electrodes prepared in in Example 1 and Comparative Examples 1 to 4 was sliced and fixed on a slide glass, and while peeling the electrode current collector, 180°—peel strength was measured. Evaluation was performed based on an average value of 3 or more measurements of peel strength.

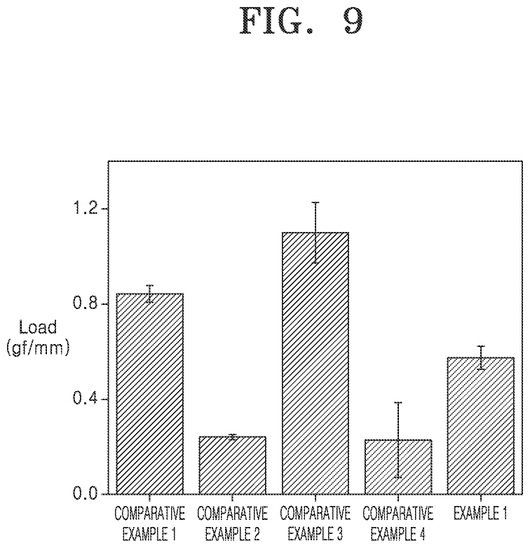

The result of electrode adhesion strength analysis is shown in FIG. 9 and Table 2.

TABLE 2

| | Binder | Cohesive strength | Standard |
|---|---|---|---|
| | Composition | (gf mm⁻¹) | Deviation |
| Comparative | CMC:SBR | 0.842 | 0.035 |
| Example 1 | 1:1.5 | | |
| Comparative | CMC-PEG:SBR | 0.241 | 0.011 |
| Example 2 | 1:1.5 | | |
| Comparative | CMC:LiPAA | 1.099 | 0.127 |
| Example 3 | 1:1.5 | | |
| Comparative | SBR:LiPAA | 0.228 | 0.158 |
| Example 4 | 1.5:1 | | |
| Example 1 | CMC-PEG:LiPAA | 0.574 | 0.048 |
| | 1:1.5 | | |

As shown in FIG. 9 and Table 2, the composite binder electrode of Example 1 containing both (e.g., simultaneously) CMC-PEG and LiPAA, with LiPAA having a good or suitable adhesive strength and CMC-PEG lacking in adhesive strength introduced together, showed a level of adhesion strength that is attributable to the electrode structure stably maintained as LiPAA compensates for the low adhesive strength of CMC-PEG.

As the electrode binder for a lithium secondary battery according to one embodiment is included in at least one of the positive electrode and the negative electrode, it is possible to provide a lithium secondary battery capable of enhancing fast charging/discharging behavior efficiency of the electrode by reducing electrode resistance generated inside the electrode during charging/discharging.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope of the disclosure as defined by the following claims and equivalents thereof.

As used herein, the term “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As used herein, the terms “use,” “using,” and “used” may be considered synonymous with the terms “utilize,” “utilizing,” and “utilized,” respectively.

The use of “may” when describing embodiments of the present disclosure refers to “one or more embodiments of the present disclosure.”

As used herein, the singular forms “a”, “an” and “the” are intended to include the plural forms as well, unless the context clearly indicates otherwise.

In the present disclosure, when particles are spherical, “size” indicates an average particle diameter, and when the particles are non-spherical, the “size” indicates a major axis length. The size of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

The vehicle, a battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

What is claimed is:

1. An electrode binder for a lithium secondary battery, the electrode binder comprising:
a cellulose-based graft copolymer in which a cellulose-based polymer is grafted with a compound having an ion-hopping site; and
a polyacrylate-based polymer comprising an anionic group via an exchange with a cation.

2. The electrode binder of claim 1, wherein the ion-hopping site is an ether group, a carbonyl group, a nitrile group, or a combination thereof.

3. The electrode binder of claim 1, wherein the compound having the ion-hopping site is a glycol-based polymer.

4. The electrode binder of claim 1, wherein the compound having the ion-hopping site is a polyethylene glycol, a polypropylene glycol, a polybutylene glycol, and derivatives thereof, or a combination thereof.

5. The electrode binder of claim 1, wherein the cellulose-based graft copolymer is grafted by a polyethylene glycol or a derivative thereof.

6. The electrode binder of claim 1, wherein the cellulose-based polymer is methylcellulose, ethylcellulose, ethylmethylcellulose, hydroxyethylcellulose, hydroxypropylcellulose, methylhydroxyethylcellulose, ethylhydroxyethylcellulose, hydroxypropylmethylcellulose, carboxymethylcellulose, and derivatives thereof, or a combination thereof.

7. The electrode binder of claim 1, wherein with respect to a total weight of the cellulose-based graft copolymer, an amount of the compound having the ion-hopping site is in a range from about 5 wt % to about 70 wt %.

8. The electrode binder of claim 1, wherein the cation is a lithium ion, a sodium ion, a potassium ion, or a combination thereof.

9. The electrode binder of claim 1, wherein the polyacrylate-based polymer comprises a lithium polyacrylate, a lithium polymethacrylate, a sodium polyacrylate, a sodium methacrylate, a potassium polyacrylate, a potassium methacrylate, or a combination thereof.

10. The electrode binder of claim 1, wherein a weight ratio of the cellulose-based graft polymer to the polyacrylate-based polymer is about 5:95 to about 95:5.

11. The electrode binder of claim 1, wherein the cellulose-based graft copolymer and the polyacrylate-based polymer is bonded by at least one non-covalent interaction selected from among a hydrogen bond, an ion-dipole interaction, and a hydrophobic interaction.

12. An electrode for a lithium secondary battery, the electrode comprising:
an electrode active material; and
the electrode binder according to claim 1.

13. The electrode of claim 12, wherein the electrode active material is a negative electrode active material.

14. The electrode of claim 13, wherein the negative electrode active material comprises a carbon-based negative electrode active material comprising a crystalline carbon, an amorphous carbon, or a mixture thereof.

15. The electrode of claim 14, wherein the carbon-based negative electrode active material comprises at least one of an artificial graphite, a natural graphite, a graphitized carbon fiber, a graphitized mesocarbon microbead, a petroleum coke, a plastic resin, a carbon fiber, or a pyrolytic carbon.

16. The electrode of claim 12, wherein, with respect to a total weight of the electrode active material and the electrode binder, an amount of the electrode active material is in a range from about 80 wt % to about 99.9 wt %, and an amount of the electrode binder is in a range from about 0.1 wt % to about 20 wt %.

17. A lithium secondary battery comprising:
a positive electrode;
a negative electrode; and
a separator between the positive electrode and the negative electrode, wherein at least one of the positive electrode or the negative electrode comprises the electrode binder according to claim 1.

18. The lithium secondary battery of claim 17, wherein the electrode binder is in the negative electrode.
